(19) United States
(12) Patent Application Publication
(10) Pub. No.: US 2024/0250436 A1
(43) Pub. Date: Jul. 25, 2024

(54) DUAL RADIO FREQUENCY ANTENNAS FOR AN IN-THE-EAR HEARING ASSISTIVE DEVICE

(71) Applicant: Team IP Holdings, LLC, Fort Worth, TX (US)

(72) Inventors: Tenvoon Wong, Milton (CA); Henry C. Smith, Bristol, PA (US); Aleksey Bernik, Warminster, PA (US); Andrew Bartle, Levittown, PA (US)

(21) Appl. No.: 18/416,022

(22) Filed: Jan. 18, 2024

Related U.S. Application Data
(60) Provisional application No. 63/440,185, filed on Jan. 20, 2023.

(51) Int. Cl. H01Q 9/06; H01Q 1/27; H01Q 1/50; H04R 25/00

(52) U.S. Cl. CPC H01Q 9/065; H01Q 1/273; H01Q 1/50; H04R 25/554; H04R 25/609; H04R 2225/025; H04R 2225/51

(57) ABSTRACT

Systems and methods are provided for dual radio frequency antennas for an in-the-ear hearing assistive device. An example dual antenna module, for use in hearing assistive devices, has, at least, a first antenna and a second antenna, with the first antenna and the second antenna configured to ensure that reception of signals via the dual antenna module meets performance criteria that includes, at least, optimizing reception of signals in a particular direction relative to a head of user when using the hearing assistive device, and having a directional radiation pattern pointing outward from an ear of the user when using the hearing assistive device.

### CLAIM OF PRIORITY

This patent application makes reference to, claims priority to, and claims benefit from U.S. Provisional Patent Application No. 63/440,185, filed on Jan. 20, 2023. The above identified application is incorporated herein by reference in its entirety.

### TECHNICAL FIELD

Aspects of the present disclosure relate to hearing assistive devices. More specifically, various implementations of the present disclosure relate to methods and systems for implementing and using dual radio frequency antennas for an in-the-ear hearing assistive device.

### BACKGROUND

An in-the-ear (ITE) hearing assistive device is typically worn with almost the entire housing lodged in the ear canal of a patient. However, conventional ITE hearing assistive devices may have some limitations and disadvantages. For example, conventional ITE hearing assistive devices may have limited or impaired performance in particular regions around the patient's head, due to, e.g., the placement and positioning of the ITE hearing assistive device.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

Certain embodiments of the present disclosure provide a dual antenna system for an hearing assistive device and a method of implementing the dual antenna system, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 illustrates an exemplary radiation pattern of an in-the-ear (ITE) hearing assistive device positioned in the ear canal of the patient.

FIG. 2 illustrates a block diagram of an exemplary dual antenna system, in accordance with embodiments of the present disclosure.

FIG. 3 illustrates exemplary first and second antennas connected through an integrated ceramic transformer to a single-ended transceiver port, in accordance with embodiments of the present disclosure.

FIG. 4 illustrates an exemplary waveform of the first antenna, in accordance with embodiments of the present disclosure.

FIG. 5 illustrates an exemplary radiation pattern of the first antenna of FIG. 4, in accordance with embodiments of the present disclosure.

FIG. 6 illustrates exemplary first and second antennas and corresponding waveforms of the first and second antennas, in accordance with embodiments of the present disclosure.

FIG. 7 illustrates an exemplary model of hollow cylinders representing ear canals in an elliptical object representing a head, in accordance with embodiments of the present disclosure.

FIG. 8 illustrates an exemplary faceplate of a hearing assistive device housing having an indented recess for securing a first antenna, in accordance with embodiments of the present disclosure.

FIG. 9 illustrates exemplary shapes that may be used for the indented recess on the faceplate of FIG. 8, in accordance with embodiments of the present disclosure.

FIG. 10 illustrates an exemplary composite dipole antenna made of printed micro-strip lines on a flexible printed circuit board and a metallic wire, in accordance with embodiments of the present disclosure.

FIG. 11 illustrates exemplary arrangements of the composite dipole antenna of FIG. 10, in accordance with embodiments of the present disclosure.

FIG. 12 illustrates another exemplary configuration of a composite antenna having primary and compound antennas adjusted for directivity in three dimensions, in accordance with embodiments of the present disclosure.

FIG. 13 illustrates an exemplary composite antenna having a second compound antenna portion protruding from a housing enclosure of a hearing assistive device, in accordance with embodiments of the present disclosure.

FIG. 14 illustrates an exemplary sinusoidal distribution of current flowing in a conductor, in accordance with embodiments of the present disclosure.

FIG. 15 illustrates an exemplary length of a first antenna carrying three half-wavelength cycles of a signal, in accordance with embodiments of the present disclosure.

FIG. 16 illustrates exemplary lengths and corresponding waveforms of a first antenna and a second antenna, in accordance with embodiments of the present disclosure.

FIG. 17 illustrates an exemplary housing, first antenna, and second antenna of a dual antenna system, in accordance with embodiments of the present disclosure.

FIG. 18 illustrates an exemplary solder point location of a second antenna to a first antenna, in accordance with embodiments of the present disclosure.

### DETAILED DESCRIPTION

Embodiments of the present disclosure provide dual antenna systems for use in hearing assistive devices and methods of implementing and/or utilizing such dual antenna systems. The foregoing summary, as well as the following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general-purpose signal processor or a block of random access memory, hard disk, or the like) or multiple pieces of hardware. Similarly, the programs may be stand-alone programs, may be incorporated as subroutines in an operating system, may be functions in an installed software package, and the like. It should be understood that the various embodiments are not limited to the arrangements and instrumentality shown in the drawings. It should also be understood that the embodiments may be combined, or that other embodiments may be utilized, and that structural, logical and electrical changes may be made without departing from the scope of the various embodiments. Therefore, the following detailed description is not to be taken in a limiting sense, and the scope of the present disclosure is defined by the appended claims and their equivalents.

As used herein, an element or step recited in the singular and preceded with the word “a” or “an” should be understood as not excluding plural of said elements or steps, unless such exclusion is explicitly stated. Furthermore, references to “an exemplary embodiment,” “various embodiments,” “certain embodiments,” “a representative embodiment,” and the like are not intended to be interpreted as excluding the existence of additional embodiments that also incorporate the recited features. Moreover, unless explicitly stated to the contrary, embodiments “comprising”, “including”, or “having” an element or a plurality of elements having a particular property may include additional elements not having that property.

Furthermore, the term processor or processing circuit, as used herein, refers to any type of processing unit that may carry out the required calculations needed for the various embodiments, such as single or multi-core: central processing unit (CPU), accelerated processing unit (APU), graphic processing unit (GPU), digital signal processor (DSP), field programmable gate array (FPGA) and application-specific integrated circuit (ASIC), or a combination thereof.

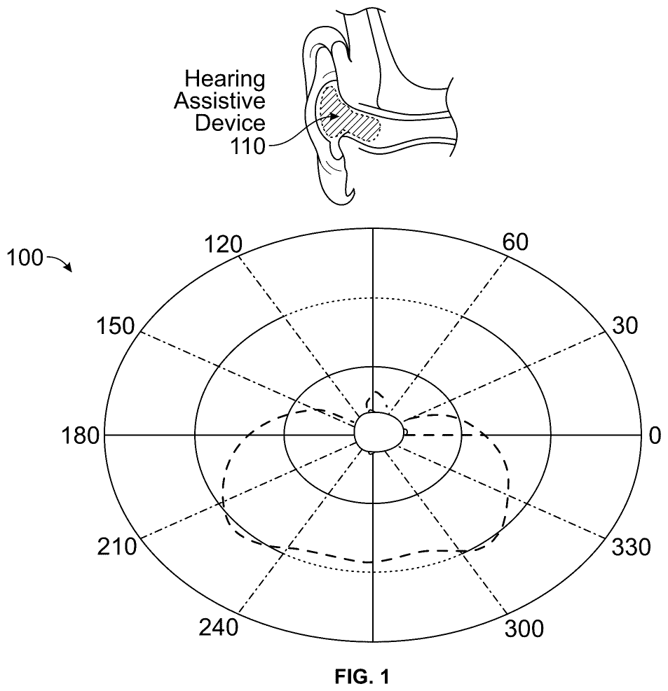

FIG. 1 illustrates an exemplary radiation pattern of an in-the-ear (ITE) hearing assistive device positioned in the ear canal of the patient. Shown in FIG. 1 is plot 100 illustrating horizontal radiation pattern for an In-the-ear (ITE) hearing assistive device 110.

As noted, an ITE hearing assistive device is typically worn with almost the entire housing lodged in the ear canal of a patient. Because of the placement of the ITE hearing assistive device in that manner, the radio frequency operation thereof may be greatly impaired, particularly due to the difficulty of electromagnetic (EM) energy propagation in the human head, as illustrated in plot 100, showing horizontal radiation pattern for the ITE hearing assistive device 110 when worn in the right ear of a patient. In this regard, the effective direct path for the EM signal propagation is limited to the horizontal plane in-line with the unobstructed area of the faceplate facing outward from the ear. Furthermore, other parts of the wearer's body may also cause further degradation in performance. For example, the shoulder of the wearer may be as an obstacle to EM energy propagating from the lower part of the body on the same side, and the entire torso blocks EM energy propagating from the lower body on the opposite side. As such, the opposite side of a head is basically a shadowed zone for a receiver when the transmitter is on the opposite side of the head as shown in plot 100.

Hence, when using the ITE hearing assistive device as a receiving device with a corresponding transmitter device, such as a mobile phone, most of the signals picked up by the receiving antenna may be multi-path signals, which are signals, originated from the transceiver, reflected by the surrounding environment. For such a system, the radio frequency performance is greatly dependent on the environment factors such as the size of the room where the user is located, the physical body height of the user, and whether it is in an indoor or outdoor environment.

Since the multipath signals could reach the antenna in a constructive or destructive manner, the changes in the environment, such as movement of the head or swinging of the arm, could quickly alter the signal strength arriving at the receiver antenna. This is the well-known multipath transmission phenomenon known as a Raleigh fading channel. The variation of signal strength may be characterized by a quantity called fade margin, which is the difference in the maximum to minimum signal level within a symbol time. For a 2.45 GHz system, the fade margin is about 22 to 30 dB. For a system that uses 2.45 GHz Bluetooth LE technology, the longer the connection interval, the higher the probability of suffering a loss of signal within the connection interval. When the loss of signal results in a corrupted symbol and the total number of corrupted symbols exceed the number of correctible symbols within the connection interval, the entire packet of data would be lost. For real time radio operation, such as audio streaming, the loss of packets results in poor audio quality.

Solutions based on the present disclosure may overcome or address issues associated with conventional solutions, particularly with respect to coverage limitations due to radio frequency operation impairment because of ITE hearing assistive device positioning. In particular, in various embodiments based on the present disclosure incorporate use of dual antenna systems for mitigating such impairments. In this regard, aspects of the present disclosure provide the technical effect of a dual antenna system operable to maximize the collection of signals from different angles of arrival in an indoor or an outdoor environment.

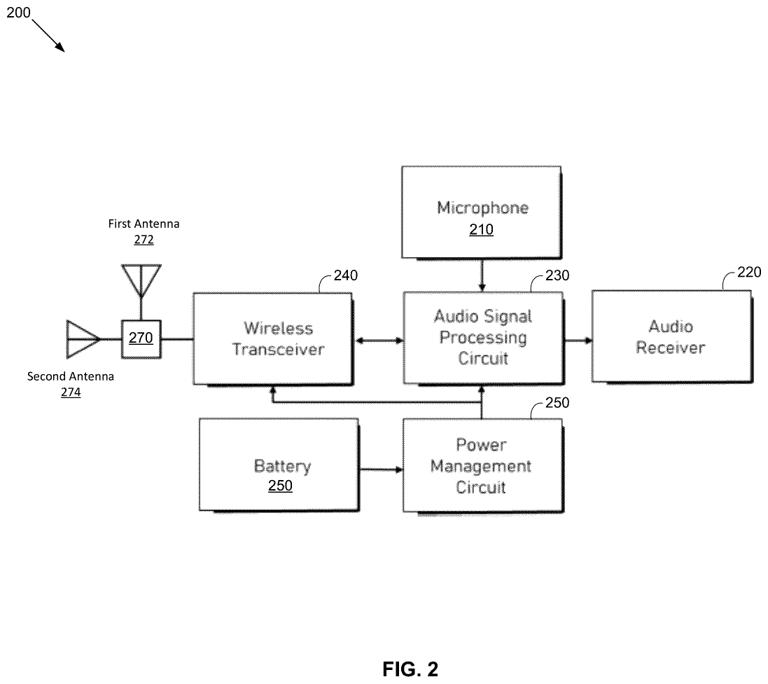

Typically, in an indoor environment, reflective surfaces include walls, a ceiling, and a floor (or ground). In an outdoor environment, the main reflective surface is the floor or the ground upon which the user stands. Positioning the antenna to collect the most signal reflected from the ground is a good strategy to normalize indoor and outdoor performance. A second strategy is to use antennas with a directional radiation pattern in lieu of an omni-directional antenna because of the severe degradation of the head, shoulder, and torso to the omni-directional radiation pattern. Sacrificing the radiation effectiveness in the directions of the head and torso may result in higher achievable gain in the desired directional aspects of the radiation pattern. Another consideration is the type of material used in the antenna, such as by using low loss material to further optimize performance. In solutions based on the present disclosure, antenna systems are designed and implemented specifically to make use of these considerations, with these antenna systems being specifically configured for use within hearing assistive devices—e.g., being deployable in ITE devices, and thus having acceptable size, weight, etc. characteristics to be incorporated into and operate within such devices. In particular, in various embodiments two antenna based systems (or dual antenna systems) may be used, being designed specifically to make use of these considerations. An example embodiment of such dual antenna system is shown in FIG. 2.

FIG. 2 illustrates a block diagram of an exemplary dual antenna system, in accordance with embodiments of the present disclosure. Shown in FIG. 2 is dual antenna system 200.

The dual antenna system 200 comprises dual antenna module 270 and related suitable circuitry and/or other hardware, which may be configured for driving and/or utilizing the dual antenna module 270. For example, as shown in the example embodiment illustrated in FIG. 2, the dual antenna system 200 comprises, in addition to the dual antenna module 270, a microphone 210, an audio receiver 220, an audio signal processing circuit 230, a wireless transceiver 240, a power management circuit 250, and a battery 260.

In operation, the dual antenna module 270 may be used to receive signals, which are then processed—e.g., via the wireless transceiver 240, the audio signal processing circuit 230, etc. The processing may allow for isolating and playing out any audio in the received signals. The battery 260 may provide power needed by other components of dual antenna system 200, with the power management circuit 250 providing necessary power management functions in the system. The audio receiver 220 and/or the microphone 210 may capture audio, which may then processed (e.g., via the audio signal processing circuit 230), and if necessary transmitted (e.g., via the wireless transceiver 240 and the dual antenna module 270).

The dual antenna module 270 comprises two antennas (a first antenna 272 and a second antenna 274) configured to operate collaboratively for improve performance (e.g., coverage) of a device incorporating the dual antenna system 200, particularly an ITE hearing assistive device as described herein. The first antenna 272 and the second antenna 274 antennas may be configured and/or selected to optimize performance, particularly with respect to mitigating coverage impairment issues as described herein. In this regard, in various example embodiments, the first antenna 272 may be an asymmetric long wire antenna having a length greater than a wavelength to achieve a directional radiation pattern pointing outward from the ear, whereas the second antenna 274 may be a short wire antenna with stub tuning in a different plane from the first antenna 272, to collect more signal in the direction of the ground. In other words, the placement and positioning of the second antenna relative to the first antenna, particularly in conjunction with other characteristics of one or both of the first antenna and the second antenna (length in terms of wavelength, etc.), ensure that the two antennas collectively provide the desired directional reception performance-particularly, capturing signals from the direction of the ground (downwards).

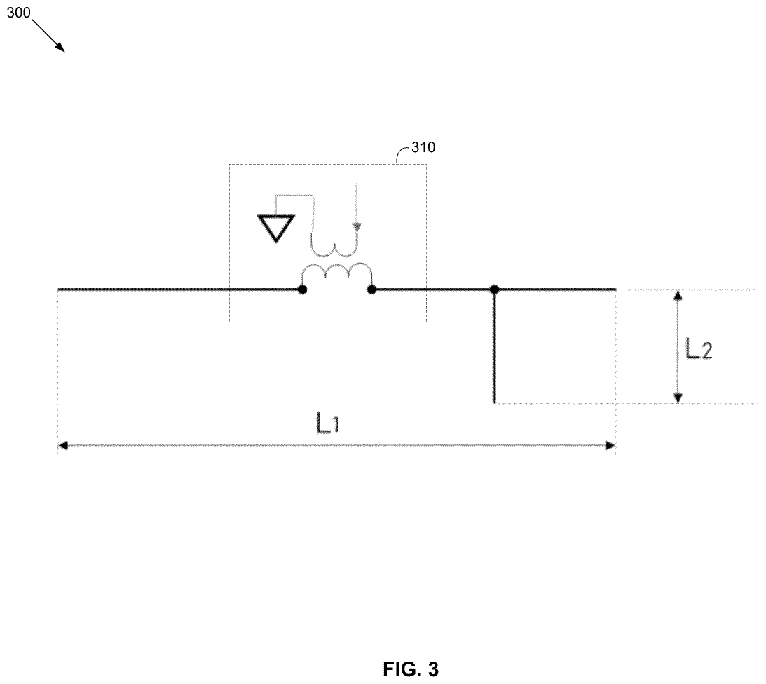

In some instances, the two antennas may be connected, such as through transformer (e.g., an integrated ceramic transformer), to a single-ended transceiver port. This arrangement is shown in FIG. 3.

FIG. 3 illustrates exemplary first and second antennas connected through an integrated ceramic transformer to a single-ended transceiver port, in accordance with embodiments of the present disclosure. Shown in FIG. 3 is the dual antenna module 270 (or portion thereof). In particular, illustrated in FIG. 3, is a portion of the dual antenna module 270 where the two antennas (first antenna 272 and second antenna 274) are connected, particularly through an integrated ceramic transformer 310, to a single-ended transceiver port. In this regard, as noted the first antenna 272 is an asymmetric long wire antenna having a length (L1), which is greater than a wavelength, to achieve a directional radiation pattern pointing outward from the ear, whereas the second antenna 274 is a short wire antenna, having a length (L2), with stub tuning in a different plane from the first antenna 272 to collect more signal in the direction of the ground. In some instances, due to potentially higher harmonic frequency operation of these antennas, the transformer 310 may also be configured to perform out-of-band signal filtering for the system.

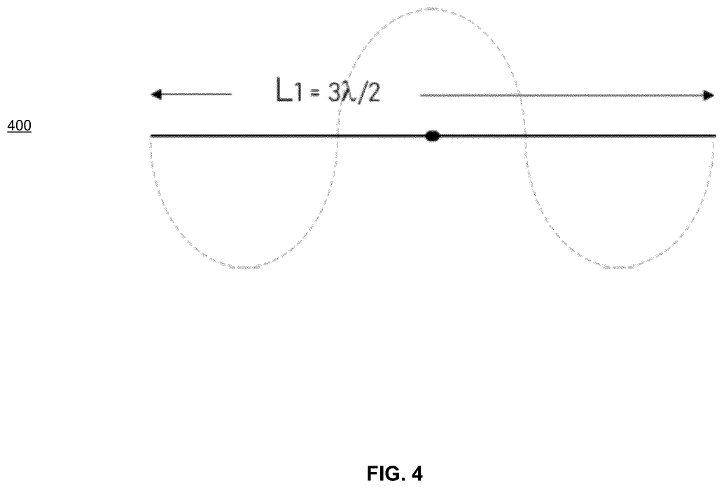

FIG. 4 illustrates an exemplary waveform of the first antenna, in accordance with embodiments of the present disclosure. Shown in FIG. 4 is the first antenna 272 of the dual antenna module 270. In this regard, as noted the first antenna 272 is an asymmetric long wire antenna having a length (L1) that is greater than a wavelength. In particular, as shown in the example embodiment illustrated in FIG. 4, the long wire antenna selected (as the first antenna 272) is a dipole with the length of 3λ/2. The current waveform on the long wire antenna is shown with dotted line in FIG. 4.

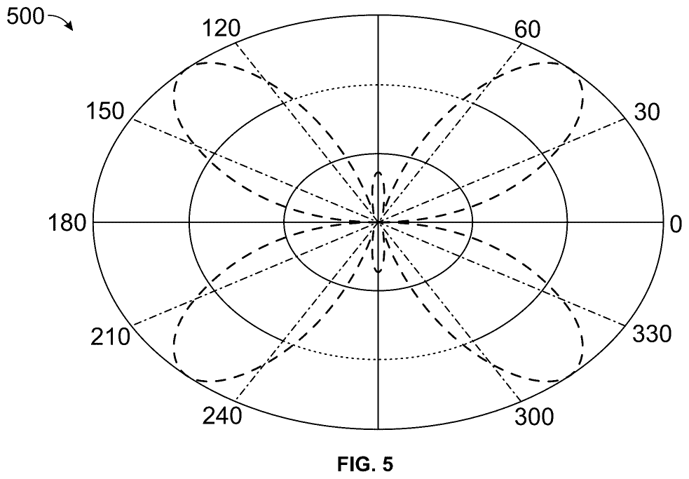

FIG. 5 illustrates an exemplary radiation pattern of the first antenna of FIG. 4, in accordance with embodiments of the present disclosure. Shown in FIG. 5 is plot 500 illustrating the radiation pattern of the first antenna 272 as shown in and described with respect to FIG. 4—that is, where the first antenna 272 is a dipole with the length of 3λ/2.

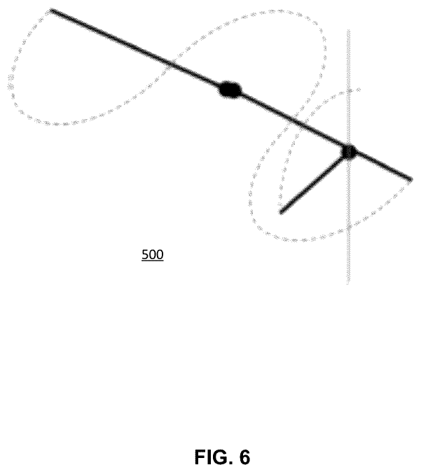

FIG. 6 illustrates exemplary first and second antennas and corresponding waveforms of the first and second antennas, in accordance with embodiments of the present disclosure. Shown in FIG. 6 are the first antenna 272 and the second antenna 274 of the dual antenna module 270, illustrating the arrangement thereof.

As noted above, in example dual antenna based embodiments described herein, such as the dual antenna system 200, the first antenna (e.g., the first antenna 272 of the dual antenna module 270) may be an asymmetric long wire antenna having a length greater than a wavelength where the second antenna (e.g., the second antenna 274 of the dual antenna module 270) may be a short wire antenna with stub tuning in a different plane from the first antenna. As shown in FIG. 6, the second antenna 274 is a whip antenna shorter than its wavelength, A, joint to one of the elements of the first antenna 272 in a location where the waveform is at its peak. The second antenna 274 is in a plane orthogonal to the first antenna 272. For example, if the first antenna 272 is on the x-z plane, then the second antenna 274 is placed along the y-axis. When the whip antenna is of the length of λ/4, the current waveform on the composite antenna is shown in FIG. 6.

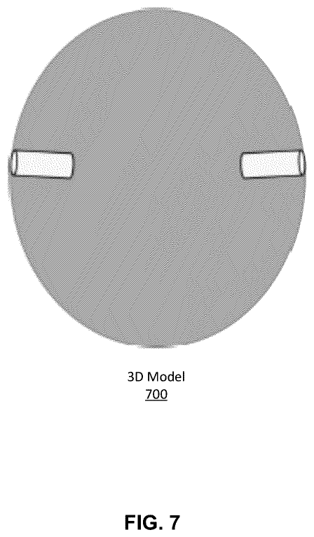

FIG. 7 illustrates an exemplary model of hollow cylinders representing ear canals in an elliptical object representing a head, in accordance with embodiments of the present disclosure. Shown in FIG. 7 is a three-dimensional (3D) model for use in conjunction with implementing and testing dual antenna systems.

In this regard, the wavelength reduction effect due to the propagation medium is preferably considered when determining the various lengths. The dielectric constant of the printed circuit board (PCB) substrate and that of the human ear canal are two factors affecting the length of the design. The dielectric constant of the substrate may be obtained from the material composition of the PCB. The equivalent model of the ear canal may initially be modeled by an elliptical 3D object for the head and a hollow cylinder representing the ear canal as shown in FIG. 7.

The material for the build-up of the elliptical head model uses the material composition and properties outlined in table 1, below:

| Material/Tissue | Dielectric | Bulk conductivity | Loss |
|---|---|---|---|
| Composition | Constant | (S/m) | tangent |
| Air | | | |
| Skin | 18.70 | 23.20 | 0.022 |
| Fat | 6.45 | 4.5 | 0.145 |
| Muscle | 27.0 | 30.0 | 0.242 |
| Skull | 5.49 | 4.54 | 0.046 |
| Dura | 21.30 | 22.2 | 0.291 |
| CSF | 31.40 | 39.5 | 0.012 |
| Brain | 21.20 | 24.9 | 0.273 |

Table 1: Simple Head model material composition and physical properties.

The physical lengths of each of the elements are determined using the approximated model described and implemented through either a printed element on a PCB or through a physical wire. The lengths may be further optimized using an EM simulation tool. As a physical method to tune for a best matching at the transceiver end, a joint of the whip may be moved similar to the operation of a tuning stub.

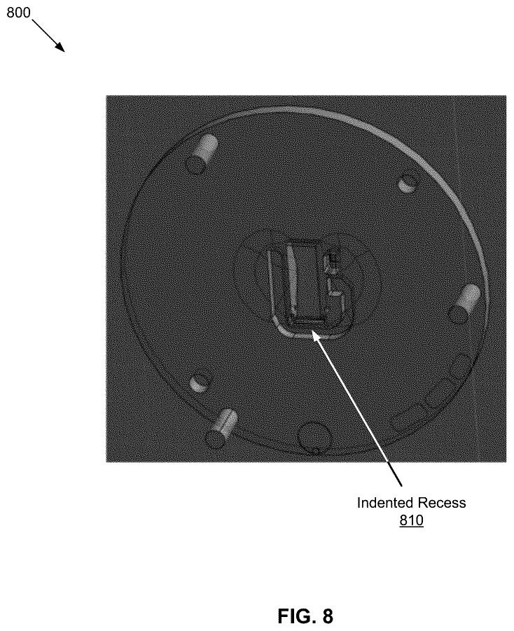

FIG. 8 illustrates an exemplary faceplate of a hearing assistive device housing having an indented recess for securing a first antenna, in accordance with embodiments of the present disclosure. Shown in FIG. 8 is a faceplate 800 of a hearing assistive device housing. In this regard, the faceplate 800 may be configured to support use of dual antenna systems as described herein. For example, the faceplate 800 may comprise an indented recess 810 configured for securing a first antenna, such as the first antenna 272 of the dual antenna module 270 as described above. In this regard, the first antenna may be secured on the faceplate 800 through the indented recess 810 as shown in FIG. 8.

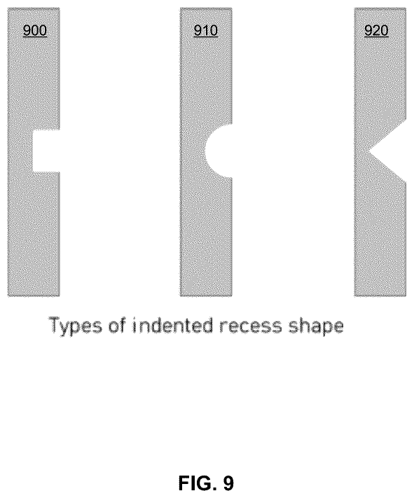

FIG. 9 illustrates exemplary shapes that may be used for the indented recess on the faceplate of FIG. 8, in accordance with embodiments of the present disclosure. Shown in FIG. 9 are faceplates 900, 910, and 920, illustrating different designs that may be used for securing the antenna of dual antenna systems described herein. Each of the faceplates 900, 910, and 920 incorporates an indented recess. In this regard, the indented recess may be made into a variety of shapes to angle the antenna placement for small refinement to the EM field as shown in FIG. 9.

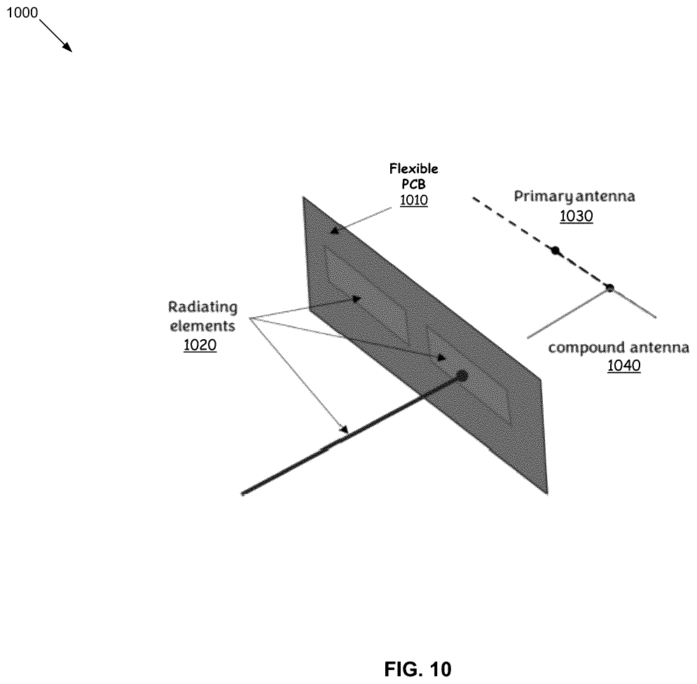

FIG. 10 illustrates an exemplary composite dipole antenna made of printed micro-strip lines on a flexible printed circuit board and a metallic wire, in accordance with embodiments of the present disclosure. Shown in FIG. 10 is composite dipole antenna 1000.

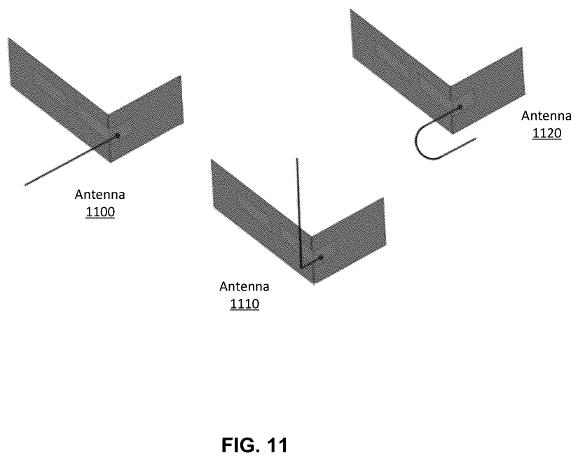

The antenna 1000 may be configured for use in dual antenna systems implemented based on the present disclosure, which may be used in hearing assistive devices as described herein. The antenna 1000 may comprise a flexible printed circuit board (PCB) 1010, and radiating elements 1020, which may comprise printed micro-strip lines on the flexible PCP 1010 with a desirable dielectric constant and a metallic wire is shown. The form of the antenna 1000 may be considered as a composite of two dipole antenna when the radiating elements 1020 are placed in different axis, or manipulated to sit on different axis, to achieve a desired radiation pattern. Examples of such arrangements are shown in FIG. 11. The two components may be considered a primary antenna 1030 (on the flexible PCP 1010), and a second compound antenna 1040, which uses part of the physical structure of the primary antenna.

FIG. 11 illustrates exemplary arrangements of the composite dipole antenna of FIG. 10, in accordance with embodiments of the present disclosure. Shown in FIG. 11 are antennas 1100, 1110, and 1120.

Each representing an example embodiment of the composite dipole antenna 1000 of FIG. 10. In particular, the antennas 1100, 1110, and 1120 represent different arrangements for placing the radiating elements 1020 of the antenna 1000 in different axis, and/or otherwise manipulating the radiating elements 1020 to sit on different axis, to achieve a desired radiation pattern.

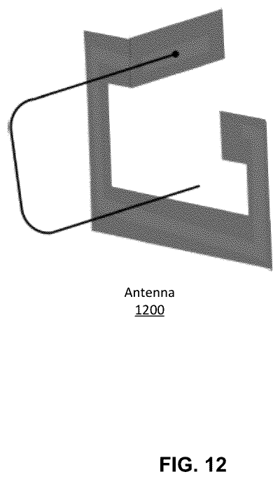

FIG. 12 illustrates another exemplary configuration of a composite antenna having primary and compound antennas adjusted for directivity in three dimensions, in accordance with embodiments of the present disclosure. Shown in FIG. 12 is antenna 12.

The antenna 1200 which represents another example embodiment of the composite dipole antenna 1000 of FIG. 10. In particular, the antenna 1200 represent different arrangement for placing the radiating elements 1020 of the antenna 1000 in different axis, and/or otherwise manipulating the radiating elements 1020 to sit on different axis, to achieve the desired radiation pattern. In this regard, the configuration of the antenna 1200 may allow for adjustment of the directivity in three dimensions through a re-orientation of the primary and compound antenna as shown in FIG. 12.

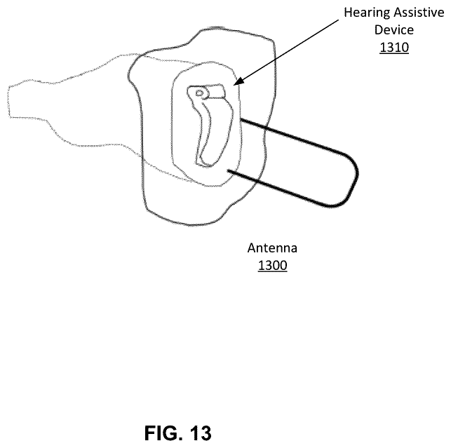

FIG. 13 illustrates an exemplary composite antenna having a second compound antenna portion protruding from a housing enclosure of a hearing assistive device, in accordance with embodiments of the present disclosure. Shown in FIG. 13 is an antenna 1300 of a hearing assistive device 1310.

The antenna 1300 may be configured for use in dual antenna systems implemented based on the present disclosure, which may be used in hearing assistive devices as described herein. The antenna 1300 may be similar to composite dipole antenna 1000 of FIG. 10. As such, the antenna 1300 may incorporate a placement arrangement, as described with respect to FIGS. 11-12, for placing the radiating elements in different axis, and/or otherwise manipulating the radiating elements to sit on different axis, to achieve the desired radiation pattern.

In this regard, with respect to all these arrangements (as shown in FIGS. 11-12), the length of the radiating elements 1020 may be selected according to the physical constraints inside a housing of a hearing aid device 1300; and part of or all of, the element of the compound element protrudes outside of the housing enclosure as shown in FIG. 13. The length of the radiating elements 1020 may be further adjusted to: (1) a desired radiation pattern and directivity, (2) a desired input impedance at the transceiver port, and/or (3) to use types of printed circuit materials for a low-cost solution.

In some instances, additional branches may be added, such as by adding other metallic wire conductor to other printed micro-strip lines-so, rather than having a single wire conductor added to one of the printed micro-strip lines, as shown in FIGS. 10-12, multiple wire conductors may be added, such as to two or more of the printed micro-strip lines. This may be done to further optimize directionality of the reception.

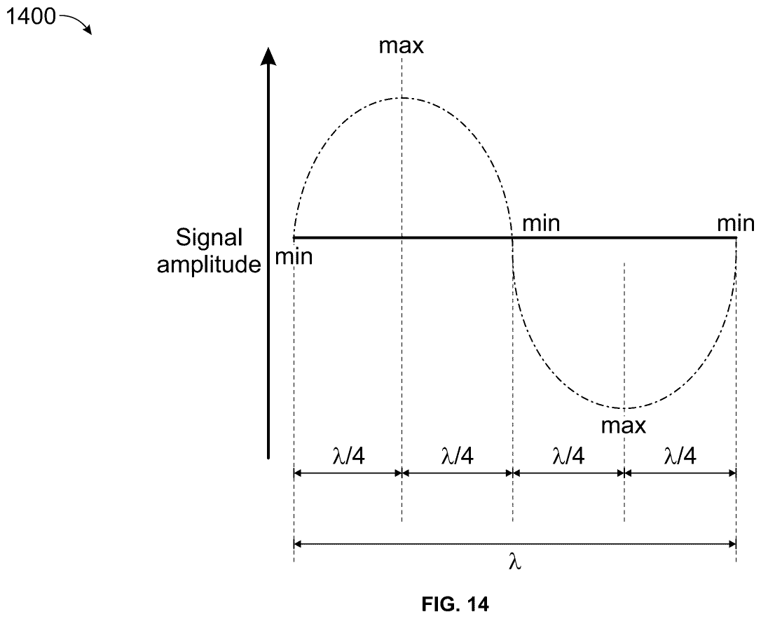

Performance data associated with example use case scenarios is provided in conjunction with FIGS. 14-18. The use case scenarios may be based on particular parameters and/or conditions, such as the frequency of operation being 2.45 GHz. In this regard, with reference to FIGS. 14-18, when a frequency of operation is 2.45 GHZ, a wavelength in free-space (air) is c/f, where c is the speed of light and f is the frequency of operation. Thus, frequency of operation being 2.45 GHZ, the wavelength λ=c/f=3×10⁸/2.45×10⁹˜0.12245 m or 122.45 mm. Thus, the length of the first antenna would be, e.g., 3/2λ=(3/2)×122.45 mm˜183.7 mm. This is the length in free space filled with air. A conductor in a different transmission medium has a reduction factor of 1/(√εᵣ), where εᵣ is the dielectric constant of the transmission medium. For example, the printed line on the flex PCB substrate has a reduction factor of 1/(√3.45)=0.538. The wavelength of a 2.45 GHz wave has a length of 122.45 mm×0.538=65.88 mm. The conductor inside the ear canal has an approximate reduction factor of 1/(√41.0)=0.156. The wavelength of a 2.45 GHz wave has a length of 122.45 mm×0.156=19.10 mm.

FIG. 14 illustrates an exemplary sinusoidal distribution of current flowing in a conductor, in accordance with embodiments of the present disclosure. Shown in FIG. 14 is plot 1400 of signal amplitude as a function of signal wavelength.

In this regard, when an electromagnetic field energy arrives at a conductor, the current flowing in the conductor is distributed sinusoidally as shown in FIG. 14. Referring to FIG. 14, a signal min-to-max interval is a quarter wavelength. The signal minimums and maximums have a half a wavelength spacing. The current is zero at the top of the two ends of the conductor. A conductor having a length equal to its wavelength carries a full cycle of its signal.

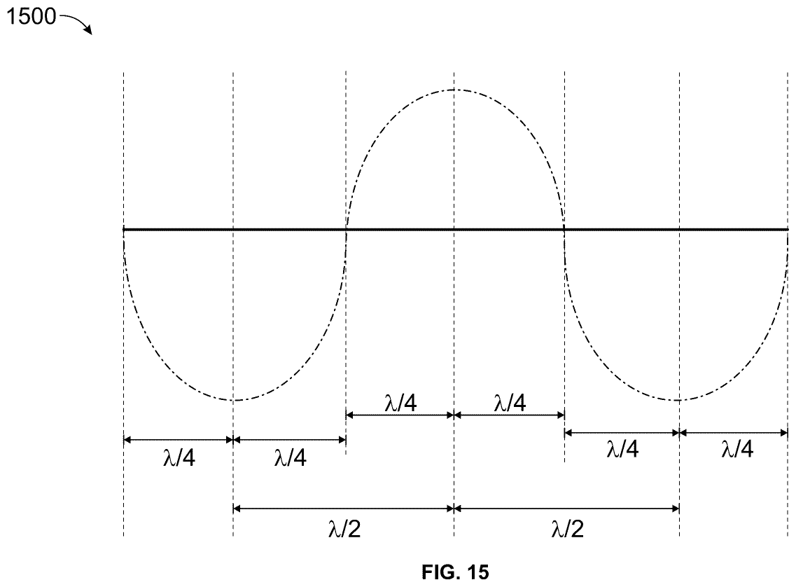

FIG. 15 illustrates an exemplary length of a first antenna carrying three half-wavelength cycles of a signal, in accordance with embodiments of the present disclosure. Shown in FIG. 15 is plot 1500 of signal amplitude as a function of signal wavelength for a first antenna in a dual antenna system as described herein.

As noted, in various embodiments the first antenna may be a 3/2λ antenna, meaning that the total length of the antenna is 3/2λ. In other words, the first antenna carries three half-wavelength cycles of signal in the conductor as shown in FIG. 15.

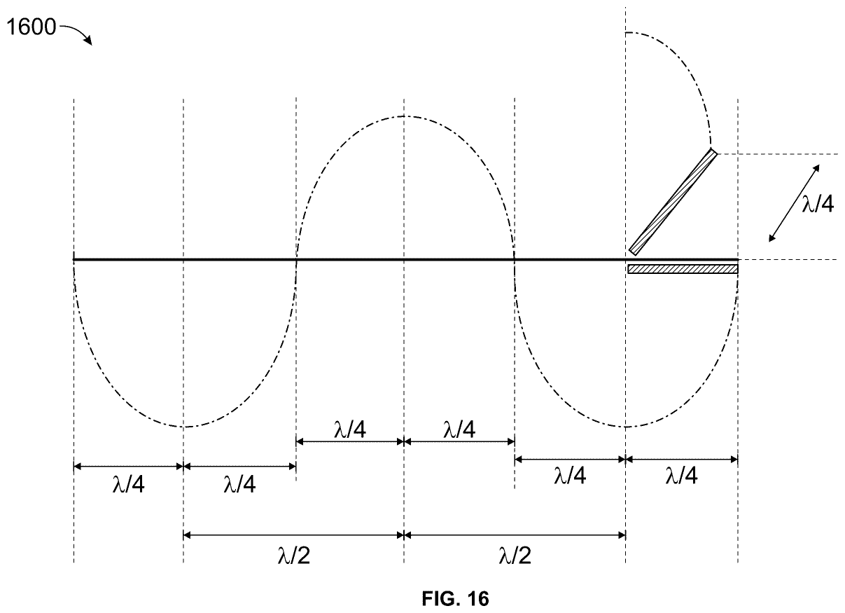

FIG. 16 illustrates exemplary lengths and corresponding waveforms of a first antenna and a second antenna, in accordance with embodiments of the present disclosure. Shown in FIG. 16 is plot 1600 of signal amplitude as a function of signal wavelength, with both a first antenna and a second antenna in a dual antenna system as described herein.

As noted, in various embodiments the second antenna is a half-way dipole, which has a total length of λ/2. As such, a quarter wavelength of the first antenna is used as half of a conductor for the second antenna, as shown in FIG. 16.

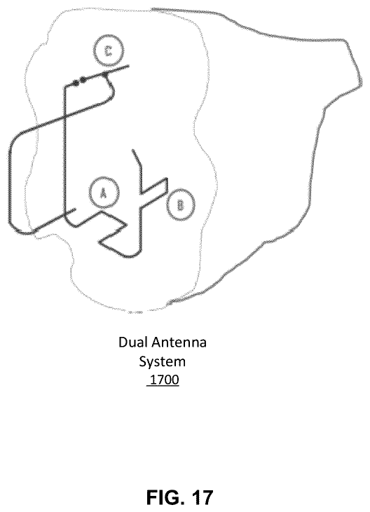

FIG. 17 illustrates an exemplary housing, first antenna, and second antenna of a dual antenna system, in accordance with embodiments of the present disclosure. Shown in FIG. 17 is a dual antenna system 1700, implemented based on an example embodiment of the present disclosure.

As shown in FIG. 17, the dual antenna system 1700 comprises a first antenna and second antenna. The first antenna is a printed line on a printed circuit board (PCB). The first antenna has three printed line sections: A, B, and C. The second antenna is provided as a physical wire conductor extending from the first antenna at printed line section C. The printed line sections A, B, and C of the first antenna are subjected to a wavelength reduction effect on the substrate as well as the reduction effect due to being physically placed in an ear canal. The wire conductor—that is, the second antenna-should have a total length of a quarter wavelength, which is approximately 122.45 mm/4(˜31 mm).

However, some portion of the length of the wire conductor may be inside the ear canal. Accordingly, the actual quarter wavelength should be less than 31 mm after adjustments. The printed line section C should be half of the length of the length of the first antenna—that is, have of 3/2λ; subjected to a reduction effect of the substrate and the propagation medium of the ear canal. In various embodiments, the layout length may be approximately 6 mm, for example.

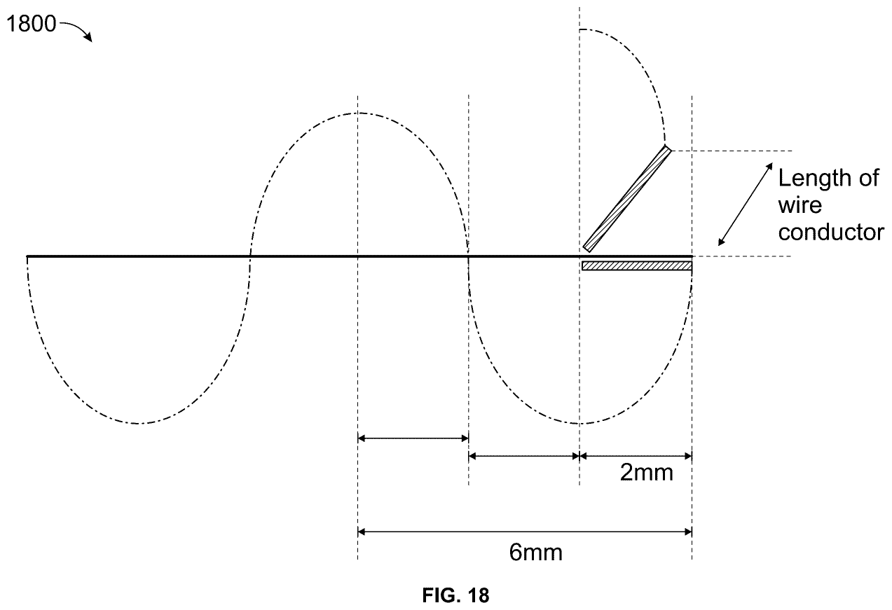

FIG. 18 illustrates an exemplary solder point location of a second antenna to a first antenna, in accordance with embodiments of the present disclosure. Shown in FIG. 18 is plot 1800 of signal amplitude as a function of signal wavelength for the dual antenna system 1700 of FIG. 17.

Referring to FIG. 18, the solder point of the wire conductor (that is, the second antenna) to the printed line should be about ⅓ of the length (of 6 mm) from the end of printed line section C as shown. In various embodiments, the length of the wire conductor (that is, the second antenna) and the location of the solder point may be fine-tuned via actual physical tuning.

An example system, in accordance with the present disclosure, comprises a hearing assistive device that comprises, at least, a dual antenna module and at least one circuit, wherein: the at least one circuit is configured to, at least, process signal communicated via the dual antenna module; the dual antenna module comprises, at least, a first antenna and a second antenna; and the first antenna and the second antenna are configured to ensure that reception of signals via the dual antenna module meets performance criteria that comprise, at least, optimizing reception of signals in a particular direction relative to a head of user when using the hearing assistive device, and having a directional radiation pattern pointing outward from an ear of the user when using the hearing assistive device.

In an example embodiment, the first antenna comprises an asymmetric long wire antenna having a length greater than a wavelength of pre-determined signal frequency.

In an example embodiment, the first antenna has a total length equal to 3/2 of the wavelength of pre-determined signal frequency.

In an example embodiment, the second antenna comprises a wire conductor antenna with stub tuning in a different plane from the first antenna, and wherein the second antenna has a length shorter than a wavelength of pre-determined signal frequency.

In an example embodiment, the second antenna has a total length equal to a quarter wavelength of a pre-determined signal frequency.

In an example embodiment, the first antenna is configured as a dipole, and wherein the second antenna is arranged as a half-way dipole.

In an example embodiment, the first antenna and the second antenna are connected to each other and/or to a single-ended transceiver port.

In an example embodiment, the dual antenna module comprises further comprises an integrated ceramic transformer, and wherein the integrated ceramic transformer connects the first antenna and the second antenna to a single-ended transceiver port.

In an example embodiment, hearing assistive device further comprises a housing having a faceplate, and wherein the faceplate is configured to support use of the dual antenna module.

In an example embodiment, the faceplate comprises an indented recess configured for securing the first antenna of the dual antenna module.

In an example embodiment, the dual antenna module comprises a printed circuit board (PCB) and a plurality of radiating elements arranged to form the first antenna and the second antenna.

In an example embodiment, the printed circuit board (PCB) comprises a flexible printed circuit board (PCB).

In an example embodiment, the plurality of radiating elements comprises one or more printed micro-strip lines on the printed circuit board (PCB) with a dielectric constant, and wherein the one or more printed micro-strip lines form the first antenna.

In an example embodiment, the plurality of radiating elements comprises one or more metallic wire conductors attached to at least one of the one or more printed micro-strip lines, and wherein the one or more metallic wire conductors form the second antenna.

In an example embodiment, the plurality of radiating elements is arranged such that different ones of plurality of radiating elements are placed and/or otherwise manipulated to sit on different axis relative to one another.

In an example embodiment, the first antenna comprises a printed line on a printed circuit board (PCB) having a plurality of printed line sections, and wherein the second antenna comprises a wire conductor extending from the first antenna at one of the plurality of printed line sections.

In an example embodiment, the plurality of printed line sections comprises three printed line sections, and wherein the wire conductor of the second antenna extends from a third printed line section from the three printed line sections.

In an example embodiment, the plurality of printed line sections of the first antenna is subjected to a wavelength reduction effect on a substrate of the printed circuit board (PCB).

In an example embodiment, the hearing assistive device comprises an in-the-ear (ITE) hearing assistive device.

In an example embodiment, the least one circuit comprises one or more of a wireless transceiver, an audio signal processing circuit, and a power management circuit.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It is to be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While various spatial and directional terms, such as top, bottom, lower, mid, lateral, horizontal, vertical, front and the like may be used to describe embodiments, it is understood that such terms are merely used with respect to the orientations shown in the drawings. The orientations may be inverted, rotated, or otherwise changed, such that an upper portion is a lower portion, and vice versa, horizontal becomes vertical, and the like.

It is to be understood that the disclosed technology is not limited in its application to the details of construction and the arrangement of the components set forth in the description or illustrated in the drawings. The technology is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system, comprising:
a hearing assistive device that comprises, at least, a dual antenna module and at least one circuit, wherein:
the at least one circuit is configured to, at least, process signal communicated via the dual antenna module;
the dual antenna module comprises, at least, a first antenna and a second antenna; and
the first antenna and the second antenna are configured to ensure that reception of signals via the dual antenna module meets performance criteria that comprise, at least, optimizing reception of signals in a particular direction relative to a head of user when using the hearing assistive device, and having a directional radiation pattern pointing outward from an ear of the user when using the hearing assistive device.

2. The system of claim 1, wherein the first antenna comprises an asymmetric long wire antenna having a length greater than a wavelength of pre-determined signal frequency.

3. The system of claim 1, wherein the first antenna has a total length equal to 3/2 of the wavelength of pre-determined signal frequency.

4. The system of claim 1, wherein the second antenna comprises a wire conductor antenna with stub tuning in a different plane from the first antenna, and wherein the second antenna has a length shorter than a wavelength of pre-determined signal frequency.

5. The system of claim 1, wherein the second antenna has a total length equal to a quarter wavelength of a pre-determined signal frequency.

6. The system of claim 1, wherein the first antenna is configured as a dipole, and wherein the second antenna is arranged as a half-way dipole.

7. The system of claim 1, wherein the first antenna and the second antenna are connected to each other and/or to a single-ended transceiver port.

8. The system of claim 1, the dual antenna module comprises further comprises an integrated ceramic transformer, and wherein the integrated ceramic transformer connects the first antenna and the second antenna to a single-ended transceiver port.

9. The system of claim 1, wherein hearing assistive device further comprises a housing having a faceplate, and wherein the faceplate is configured to support use of the dual antenna module.

10. The system of claim 9, wherein the faceplate comprises an indented recess configured for securing the first antenna of the dual antenna module.

11. The system of claim 1, wherein the dual antenna module comprises a printed circuit board (PCB) and a plurality of radiating elements arranged to form the first antenna and the second antenna.

12. The system of claim 1, wherein the printed circuit board (PCB) comprises a flexible printed circuit board (PCB).

13. The system of claim 12, wherein the plurality of radiating elements comprises one or more printed micro-strip lines on the printed circuit board (PCB) with a dielectric constant, and wherein the one or more printed micro-strip lines form the first antenna.

14. The system of claim 13, wherein the plurality of radiating elements comprises one or more metallic wire conductors attached to at least one of the one or more printed micro-strip lines, and wherein the one or more metallic wire conductors form the second antenna.

15. The system of claim 11, wherein the plurality of radiating elements is arranged such that different ones of plurality of radiating elements are placed and/or otherwise manipulated to sit on different axis relative to one another.

16. The system of claim 1, wherein the first antenna comprises a printed line on a printed circuit board (PCB) having a plurality of printed line sections, and wherein the second antenna comprises a wire conductor extending from the first antenna at one of the plurality of printed line sections.

17. The system of claim 16, wherein the plurality of printed line sections comprises three printed line sections, and wherein the wire conductor of the second antenna extends from a third printed line section from the three printed line sections.

18. The system of claim 1, wherein the plurality of printed line sections of the first antenna is subjected to a wavelength reduction effect on a substrate of the printed circuit board (PCB).

19. The system of claim 1, wherein the hearing assistive device comprises an in-the-ear (ITE) hearing assistive device.

20. The system of claim 1, wherein the least one circuit comprises one or more of a wireless transceiver, an audio signal processing circuit, and a power management circuit.
